(19) United States
(12) Patent Application Publication
(10) Pub. No.: US 2026/0103427 A1
(43) Pub. Date: Apr. 16, 2026

(54) GYPSUM BOARDS AND METHODS OF MAKING THEM

(71) Applicant: CERTAINTEED GYPSUM, INC., Malvern, PA (US)

(72) Inventors: Dahlia N. AMATO, Malvern, PA (US); Patrick R. McGINLEY, Phoenixville, PA (US); Remi LESPIAT, Devon, PA (US); Serge ADJOUA, Mason, OH (US); Roger D. JONES, Fleming Island, FL (US); Michael P. FAHEY, St. Petersburg, FL (US); David L. SERRECCHIA, Carmel, NY (US)

(21) Appl. No.: 19/357,731

(22) Filed: Oct. 14, 2025

Related U.S. Application Data
(60) Provisional application No. 63/707,505, filed on Oct. 15, 2024.

(51) Int. Cl. C04B 28/14; C04B 14/42; C04B 103/40; C04B 111/00

(52) U.S. Cl. CPC C04B 28/14; C04B 14/42; C04B 2103/408; C04B 2111/0062

(57) ABSTRACT

A gypsum-based construction material may include a gypsum core. The gypsum core may have a core bubble median size (D50) of at least about 150 microns and not greater than about 600 microns, and a contacting bubble surface percentage of not greater than about 50%. The gypsum core may further have a water absorption of not greater than about 5.0%.

### CROSS-REFERENCE TO RELATED APPLICATION(S)

This application claims priority under 35 U.S.C. § 119(e) to U.S. Provisional Patent Application No. 63/707,505, entitled “GYPSUM BOARDS AND METHODS OF MAKING THEM,” filed Oct. 15, 2024, by Dahlia N. AMATO et al., which is assigned to the current assignee hereof and is incorporated herein by reference in its entirety.

### FIELD OF THE DISCLOSURE

The present disclosure relates to gypsum boards with improved bubble configurations for moisture control and methods of making the same.

### BACKGROUND

Gypsum building products (e.g., known variously as wallboard, ceiling board, plasterboard, and “drywall”) are panels made of a gypsum core sandwiched between two layers of liner, often paper, on the outside surfaces of the gypsum core. They are widely used as construction materials due to their ease of fabrication, high mechanical strength, low thermal conductivity, resistance to spread of fire, and soundproofing properties. The quality of a gypsum board is strongly dependent on its gypsum core, which is fabricated by the hydration of stucco slurry (mainly containing calcium sulfate hemihydrate) into a set body of calcium sulfate dihydrate. To control the properties of gypsum boards, additives are often added to the stucco slurry during the board making process. For example, foaming agents, inorganic compounds, and other additives may be included in the slurry to modulate the surface density, strength, and/or fire resistance properties of the board.

Bubble (i.e., porosity) characteristics (i.e., size, shape, distribution, etc.) of the gypsum cores in gypsum-based construction materials can improve moisture absorption of the gypsum-based construction materials. Accordingly, there is a need in the art to find methods and compositions that allow for improved control of bubble characteristics in gypsum cores of gypsum-based construction materials.

### SUMMARY

According to one aspect, a method of forming a gypsum-based construction material may include providing a stucco-based slurry composition and forming the stucco-based slurry composition into a gypsum-based construction material. The stucco-based slurry composition may include a surfactant at a content of at least about 0.10 wt. % and not greater than about 1.0 wt. % for a total weight of the stucco-based slurry composition. The surfactant may further include an alkyl ether sulfate, an ethoxylated surfactant, a lauryl surfactant, an alcohol, or any combination thereof. The gypsum-based construction material formed from the stucco-based slurry composition may include a gypsum core. The gypsum core may have a core bubble median size (D50) of at least about 150 microns and not greater than about 600 microns, and a contacting bubble surface percentage of not greater than about 50%. The gypsum core may further have a water absorption of not greater than about 5.0%.

According to another aspect, a gypsum-based construction material may be formed from a stucco-based slurry composition. The stucco-based slurry composition may include a surfactant at a content of at least about 0.10 wt. % and not greater than about 1.0 wt. % for a total weight of the stucco-based slurry composition. The surfactant may further include an alkyl ether sulfate, an ethoxylated surfactant, a lauryl surfactant, an alcohol, or any combination thereof. The gypsum-based construction material may include a gypsum core. The gypsum core may have a core bubble median size (D50) of at least about 150 microns and not greater than about 600 microns, and a contacting bubble surface percentage of not greater than about 50%. The gypsum core may further have a water absorption of not greater than about 5.0%.

According to still another aspect, a gypsum-based construction material may include a gypsum core. The gypsum core may have a core bubble median size (D50) of at least about 150 microns and not greater than about 600 microns, and a contacting bubble surface percentage of not greater than about 50%. The gypsum core may further have a water absorption of not greater than about 5.0%.

According to one aspect, a method of forming a gypsum-based construction material may include providing a stucco-based slurry composition and forming the stucco-based slurry composition into a gypsum-based construction material. The stucco-based slurry composition may include a dispersant component at a content of at least about 0.1 wt. % and not greater than about 1.0 wt. % for a total weight of the stucco-based slurry composition. The gypsum-based construction material formed from the stucco-based slurry composition may include a gypsum core. The gypsum core may have a core bubble median size (D50) of at least about 150 microns and not greater than about 600 microns, and a contacting bubble surface percentage of not greater than about 50%. The gypsum core may further have a water absorption of not greater than about 5.0%.

According to another aspect, a gypsum-based construction material may be formed from a stucco-based slurry composition. The stucco-based slurry composition may include a dispersant component at a content of at least about 0.1 wt. % and not greater than about 1.0 wt. % for a total weight of the stucco-based slurry composition. The gypsum-based construction material may include a gypsum core. The gypsum core may have a core bubble median size (D50) of at least about 150 microns and not greater than about 600 microns, and a contacting bubble surface percentage of not greater than about 50%. The gypsum core may further have a water absorption of not greater than about 5.0%.

### BRIEF DESCRIPTION OF THE DRAWINGS

The present disclosure may be better understood, and its numerous features and advantages made apparent to those skilled in the art by referencing the accompanying drawings.

FIG. 1 includes a diagram showing a gypsum-based construction material forming method according to embodiments described herein:

FIGS. 2A-2C include images of the bubble composition for sample gypsum-based construction materials formed according to embodiments described herein;

FIGS. 3A and 3B include images of the bubble composition for sample gypsum-based construction materials formed according to embodiments described herein;

FIGS. 4A and 4B include images of the bubble composition for sample gypsum-based construction materials formed according to embodiments described herein.

Skilled artisans appreciate that elements in the figures are illustrated for simplicity and clarity and have not necessarily been drawn to scale.

### DETAILED DESCRIPTION

The following description in combination with the figures is provided to assist in understanding the teachings disclosed herein. The following discussion will focus on specific implementations and embodiments of the teachings. This focus is provided to assist in describing the teachings and should not be interpreted as a limitation on the scope or applicability of the teachings.

As used herein, the terms “comprises,” “comprising,” “includes,” “including,” “has,” “having” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus.

As used herein, and unless expressly stated to the contrary, “or” refers to an inclusive-or and not to an exclusive-or. For example, a condition A or B is satisfied by any one of the following: A is true (or present), and B is false (or not present), A is false (or not present) and B is true (or present), and both A and B are true (or present).

Also, the use of “a” or “an” are employed to describe elements and components described herein. This is done merely for convenience and to give a general sense of the scope of the invention. This description should be read to include one or at least one and the singular also includes the plural unless it is obvious that it is meant otherwise.

The use of the word “about,” “approximately,” or “substantially” is intended to mean that a value of a parameter is close to a stated value or position. However, minor differences may prevent the values or positions from being exactly as stated. Thus, differences of up to ten percent (10%) for the value are reasonable differences from the ideal goal of exactly as described.

Unless otherwise defined, all technical and scientific terms used herein have the same meaning as commonly understood by one of ordinary skill in the art to which this invention belongs. The materials, methods, and examples are illustrative only and not intended to be limiting. To the extent not described herein, many details regarding specific materials and processing acts are conventional and may be found in textbooks and other sources within the construction products arts.

Embodiments described herein are generally directed to a gypsum-based construction material and methods of forming the same. More particularly, embodiments described herein are directed to a gypsum-based construction material that includes a gypsum core having a particular core bubble and contacting bubble surface percentage that facilitate reduced water absorption.

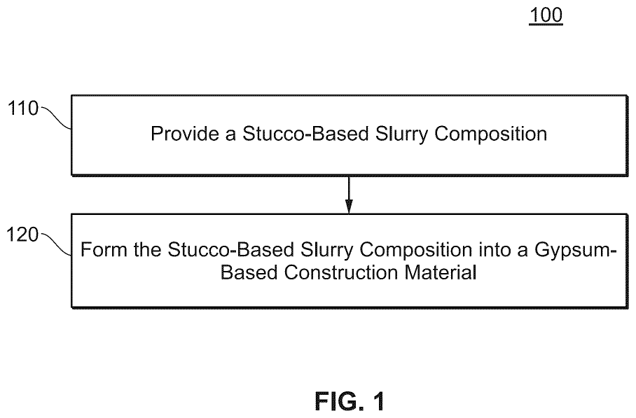

For purposes of illustration, FIG. 1 includes a diagram showing a gypsum-based construction material forming method 100 according to particular embodiments described herein. As shown in FIG. 1, the gypsum-based construction material forming method 100 may include a first step 110 of providing a stucco-based slurry composition, and a second step 120 of forming the stucco-based slurry composition into a gypsum-based construction material that includes a gypsum core.

Referring specifically to the first step 110, according to certain embodiments, the stucco-based slurry composition may include a surfactant. According to certain embodiments, the surfactant may include an alkyl ether sulfate, an ethoxylated surfactant, a lauryl surfactant, an alcohol, or any combination thereof particular content of a surfactant. According to still other embodiments, the surfactant may consist essentially of an alkyl ether sulfate, an ethoxylated surfactant, a lauryl surfactant, an alcohol, or any combination thereof. According to yet other embodiments, the surfactant may be an alkyl ether sulfate surfactant. According to still other embodiments, the surfactant may be an ethoxylated surfactant. According to yet other embodiments, the surfactant may be a lauryl surfactant. According to still other embodiments, the surfactant may be an alcohol surfactant.

According to certain embodiments, the surfactant may be considered a stable surfactant. For purposes of embodiments described herein, a stable surfactant may be defined as a surfactant developed to maximize air entrainment and minimize usage in gypsum board slurries.

According to still other embodiments, the surfactant may be considered an unstable surfactant. For purposes of embodiments described herein, an unstable surfactant may be defined as a surfactant that is a foaming agent that may produce copious volumes of foam but becomes unstable upon contact with gypsum slurries. An example is a foaming agent represented by the formula R OCO₃-M+, where R is an alkyl group containing 6-20 carbon atoms and M+ is a cation.

According to still other embodiments, the surfactant may be a pre-blended unstable soap. According to certain embodiments, the pre-blended unstable surfactant may use a predominant amount of an alkyl sulfate oligomer. According to particular embodiments, a surfactant may include a blend of surfactants, where one is represented by the formula: CH.sub.3 (CH.sub.2).sub.X CH.sub.2 (OCH.sub.2 CH.sub.2).sub. Y OSO.sub.3-M+, where X ranges from 2 to 20, Y ranges from 0 to 10 with a major portion of Y being greater than 0 and M is a cation, and a second is represented by the formula R OSO.sub.3-M+ wherein R is an alkyl group containing 2 to 20 carbon atoms and M is a cation. More preferably X ranges from 4 to 16, Y ranges from 1 to 6 and R is an alkyl radical containing 4 to 16 carbon atoms. In the best mode, X ranges from 6 to 12, Y ranges from 2 to 4 and R is an alkyl radical containing 6 to 12 carbon atoms. In both surfactants of the blend, the alkyl sulfate and alkyl ether sulfate are produced having an oligomer distribution where average values for X, Y and the number of alkyl radicals therefor are presented. According to certain embodiments, either cation may be selected from the group consisting of sodium, potassium, magnesium, ammonium, quaternary ammonium, and mixtures thereof. Preferably, each cation is either sodium or ammonium. According to still other embodiments, the ratio by weight of the first foaming agent to the second foaming agent generally is less than 50/50. Typically, it ranges from <50/50 to 0/100. Preferably, the ratio ranges from 40/60 to 0/100. More preferably, it ranges from 40/60 to 10/90. Preblended foaming agents are represented by the formula: ZH.sub.3 (CH.sub.2).sub.X CH.sub.2 (OCH.sub.2 CH.sub.2).sub. Y OSO.sub.3-M+, where X ranges from 2 to 20, Y ranges from 0 to 10 with at least 85 percent of Y being zero but with at least some of Y being greater than zero, and M is a cation. Preferably, 85 to 95 percent of Y is zero.

According to still other embodiments, the stucco-based slurry composition may include a particular surfactant content where the surfactant content is equal to the content of the surfactant in the stucco-based slurry composition in weight percent (wt. %) for a total weight of the stucco-based slurry composition. For example, the stucco-based slurry composition may include a surfactant content of at least about 0.10 wt. % for a total weight of the stucco-based slurry composition, such as, at least about 0.15 wt. % or at least about 0.20 wt. % or at least about 0.25 wt. % or at least about 0.30 wt. % or at least about 0.35 wt. % or at least about 0.40 wt. % or even at least about 0.45 wt. %. According to still other embodiments, the stucco-based slurry composition may include a surfactant content of not greater than about 1.0 wt. % for a total weight of the stucco-based slurry composition, such as, not greater than about 0.95 wt. % or not greater than about 0.90 wt. % or not greater than about 0.85 wt. % or not greater than about 0.80 wt. % or not greater than about 0.75 wt. % or not greater than about 0.70 wt. % or not greater than about 0.65 wt. % or not greater than about 0.60 wt. % or even not greater than about 0.55 wt. %. It will be appreciated that the surfactant content in the stucco-based slurry composition may be within a range between any of the minimum and maximum values noted above. It will be further appreciated that the surfactant content in the stucco-based slurry composition may be any value between any of the minimum and maximum values noted above.

According to yet other embodiments, the stucco-based slurry composition may further include a stucco component. According to certain embodiments, the stucco component may include synthetic stucco, natural stucco, recycled stucco, or any combination thereof. According to still other embodiments, the stucco component may consist essentially of synthetic stucco, natural stucco, recycled stucco, or any combination thereof. According to yet other embodiments, the stucco component may be synthetic stucco. According to still other embodiments, the stucco component may be natural stucco. According to other embodiments, the stucco component may be recycled stucco.

According to still other embodiments, the stucco-based slurry composition may include a particular stucco component content, where the stucco component content is equal to the content of the stucco component in the stucco-based slurry composition in weight percent (wt. %) for a total weight of the stucco-based slurry composition. For example, the stucco-based slurry composition may include a stucco component content of at least about 10 wt. % for a total weight of the stucco-based slurry composition, such as, at least about 15 wt. % or at least about 20 wt. % or at least about 25 wt. % or at least about 30 wt. % or at least about 35 wt. % or at least about 40 wt. % or even at least about 45 wt. %. According to still other embodiments, the stucco-based slurry composition may include a stucco component content of not greater than about 95 wt. % for a total weight of the stucco-based slurry composition, such as, not greater than about 90 wt. % or not greater than about 85 wt. % or not greater than about 80 wt. % or not greater than about 75 wt. % or not greater than about 70 wt. % or not greater than about 65 wt. % or not greater than about 60 wt. % or even not greater than about 55 wt. %. It will be appreciated that the stucco component content in the stucco-based slurry composition may be within a range between any of the minimum and maximum values noted above. It will be further appreciated that the stucco component content in the stucco-based slurry composition may be any value between any of the minimum and maximum values noted above.

According to yet other embodiments, the stucco-based slurry composition may further include a reinforcement component. According to certain embodiments, the reinforcement component may include glass fibers. According to still other embodiments, the reinforcement component may consist essentially of glass fibers.

According to still other embodiments, the stucco-based slurry composition may include a particular reinforcement component content, where the reinforcement component content is equal to the content of the reinforcement component in the stucco-based slurry composition in weight percent (wt. %) relative to the total weight of the stucco component in the stucco-based slurry composition. For example, the stucco-based slurry composition may include a reinforcement component content of at least about 0.03 wt. % relative to the total weight of the stucco component in the stucco-based slurry composition, such as, at least about 0.05 wt. % or at least about 0.1 wt. % or at least about 0.5 wt. % or at least about 1.0 wt. % or at least about 1.5 wt. % or at least about 2.0 wt. % or even at least about 2.5 wt. %. According to still other embodiments, the stucco-based slurry composition may include a reinforcement component content of not greater than about 10 wt. % for a total weight of the stucco-based slurry composition, such as, not greater than about 9.5 wt. % or not greater than about 8.0 wt. % or not greater than about 8.5 wt. % or not greater than about 8.0 wt. % or not greater than about 7.5 wt. % or not greater than about 7.0 wt. % or not greater than about 6.5 wt. % or not greater than about 6.0 wt. % or even not greater than about 5.5 wt. %. It will be appreciated that the reinforcement component content in the stucco-based slurry composition may be within a range between any of the minimum and maximum values noted above. It will be further appreciated that the reinforcement component content in the stucco-based slurry composition may be any value between any of the minimum and maximum values noted above.

According to yet other embodiments, the stucco-based slurry composition may further include a starch component. According to certain embodiments, the starch component may include an acid modified starch, a chemically modified starch, a natural starch, a corn starch, a sorghum starch, a wheat starch, a tapioca starch, a rice starch, a pea starch, a potato starch, a maize starch, or any combination thereof. According to still other embodiments, the starch component may consist essentially of an acid modified starch, a chemically modified starch, a natural starch, a corn starch, a sorghum starch, a wheat starch, a tapioca starch, a rice starch, a pea starch, a potato starch, a maize starch, or any combination thereof.

According to still other embodiments, the stucco-based slurry composition may include a particular starch component content, where the starch component content is equal to the content of the starch component in the stucco-based slurry composition in weight percent (wt. %) relative to the total weight of the stucco component in the stucco-based slurry composition. For example, the stucco-based slurry composition may include a starch component content of at least about 0.001 wt. % relative to the total weight of the stucco component in the stucco-based slurry composition, such as, at least about 0.005 wt. % or at least about 0.01 wt. % or at least about 0.05 wt. % or at least about 0.1 wt. % or at least about 0.5 wt. % or even at least about 1.0 wt. %. According to still other embodiments, the stucco-based slurry composition may include a starch component content of not greater than about 1.50 wt. % for a total weight of the stucco-based slurry composition, such as, not greater than about 1.45 wt. % or not greater than about 1.40 wt. % or not greater than about 1.35 wt. % or not greater than about 1.30 wt. % or not greater than about 1.25 wt. % or not greater than about 1.20 wt. % or not greater than about 1.15 wt. % or not greater than about 1.10 wt. % or even not greater than about 1.05 wt. %. It will be appreciated that the starch component content in the stucco-based slurry composition may be within a range between any of the minimum and maximum values noted above. It will be further appreciated that the starch component content in the stucco-based slurry composition may be any value between any of the minimum and maximum values noted above.

According to yet other embodiments, the stucco-based slurry composition may further include an accelerator component. According to certain embodiments, the accelerator component may include a heat-resistant gypsum accelerator. According to still other embodiments, the accelerator component may consist essentially of a heat-resistant gypsum accelerator. According to still other embodiments, the heat-resistant gypsum accelerator may be in a liquid form. According to yet other embodiments, the heat-resistant gypsum accelerator may be in a solid form.

According to still other embodiments, the stucco-based slurry composition may include a particular accelerator component content, where the accelerator component content is equal to the content of the accelerator component in the stucco-based slurry composition in weight percent (wt. %) relative to the total weight of the stucco component in the stucco-based slurry composition. For example, the stucco-based slurry composition may include an accelerator component content of at least about 0.1 wt. % relative to the total weight of the stucco component in the stucco-based slurry composition, such as, at least about 0.25 wt. % or at least about 0.5 wt. % or at least about 0.75 wt. % or at least about 1.0 wt. % or at least about 1.5 wt. % or even at least about 2.0 wt. %. According to still other embodiments, the stucco-based slurry composition may include an accelerator component content of not greater than about 5.0 wt. % for a total weight of the stucco-based slurry composition, such as, not greater than about 4.5 wt. % or not greater than about 4.0 wt. % or not greater than about 3.5 wt. % or not greater than about 3.0 wt. % or even not greater than about 2.5 wt. %. It will be appreciated that the accelerator component content in the stucco-based slurry composition may be within a range between any of the minimum and maximum values noted above. It will be further appreciated that the accelerator component content in the stucco-based slurry composition may be any value between any of the minimum and maximum values noted above.

According to yet other embodiments, the stucco-based slurry composition may further include a guar gum component. According to certain embodiments, the guar gum component may include a native guar gum, a chemically modified guar gum, or any combination thereof. According to still other embodiments, the guar gum component may consist essentially of a native guar gum, a chemically modified guar gum, or any combination thereof a heat-resistant gypsum accelerator.

According to yet other embodiments, the stucco-based slurry composition may further include a siloxane component. According to certain embodiments, the siloxane component may include polymethylhydrosiloxane (PMHS), polydimethylsiloxane (PDMS), a silanol containing siloxane, or any combination thereof. According to still other embodiments, the siloxane component may consist essentially of polymethylhydrosiloxane (PMHS), polydimethylsiloxane (PDMS), a silanol containing siloxane, or any combination thereof.

According to still other embodiments, the stucco-based slurry composition may include a particular siloxane component content, where the siloxane component content is equal to the content of the siloxane component in the stucco-based slurry composition in weight percent (wt. %) relative to the total weight of the stucco component in the stucco-based slurry composition. For example, the stucco-based slurry composition may include a siloxane component content of at least about 0.1 wt. % relative to the total weight of the stucco component in the stucco-based slurry composition, such as, at least about 0.2 wt. % or at least about 0.3 wt. % or at least about 0.4 wt. % or at least about 0.5 wt. % or at least about 0.6 wt. % or even at least about 0.7 wt. %. According to still other embodiments, the stucco-based slurry composition may include an siloxane component content of not greater than about 2.0 wt. % for a total weight of the stucco-based slurry composition, such as, not greater than about 1.9 wt. % or not greater than about 1.8 wt. % or not greater than about 1.7 wt. % or not greater than about 1.6 wt. % or even not greater than about 1.5 wt. %. It will be appreciated that the siloxane component content in the stucco-based slurry composition may be within a range between any of the minimum and maximum values noted above. It will be further appreciated that the siloxane component content in the stucco-based slurry composition may be any value between any of the minimum and maximum values noted above.

According to yet other embodiments, the stucco-based slurry composition may further include a dispersant component. According to certain embodiments, the dispersant component may include polynaphthalene sulfonate, ligno sulfonate, polyaryl ether poly carboxylate, or any combination thereof. According to still other embodiments, the dispersant component may consist essentially of polynaphthalene sulfonate, ligno sulfonate, polyaryl ether poly carboxylate, or any combination thereof.

According to still other embodiments, the stucco-based slurry composition may include a particular dispersant component content, where the dispersant component content is equal to the content of the dispersant component in the stucco-based slurry composition in weight percent (wt. %) relative to the total weight of the stucco component in the stucco-based slurry composition. For example, the stucco-based slurry composition may include a dispersant component content of at least about 0.1 wt. % relative to the total weight of the stucco component in the stucco-based slurry composition, such as, at least about 0.2 wt. % or at least about 0.3 wt. % or even at least about 0.4 wt. %. According to still other embodiments, the stucco-based slurry composition may include an dispersant component content of not greater than about 1.0 wt. % for a total weight of the stucco-based slurry composition, such as, not greater than about 0.9 wt. % or not greater than about 0.8 wt. % or not greater than about 0.7 wt. % or not greater than about 0.6 wt. % or even not greater than about 0.5 wt. %. It will be appreciated that the dispersant component content in the stucco-based slurry composition may be within a range between any of the minimum and maximum values noted above. It will be further appreciated that the dispersant component content in the stucco-based slurry composition may be any value between any of the minimum and maximum values noted above.

According to yet other embodiments, the stucco-based slurry composition may further include a water component.

According to still other embodiments, the stucco-based slurry composition may include a particular water component content, where the water component content is equal to the content of the water component in the stucco-based slurry composition in weight percent (wt. %) relative to the total weight of the stucco component in the stucco-based slurry composition. For example, the stucco-based slurry composition may include a water component content of at least about 50 wt. % relative to the total weight of the stucco component in the stucco-based slurry composition, such as, at least about 53 wt. % or at least about 55 wt. % or at least about 58 wt. % or at least about 60 wt. % or even at least about 63 wt. %. According to still other embodiments, the stucco-based slurry composition may include a water component content of not greater than about 90 wt. % for a total weight of the stucco-based slurry composition, such as, not greater than about 88 wt. % or not greater than about 85 wt. % or not greater than about 83 wt. % or not greater than about 80 wt. % or not greater than about 78 wt. % or even not greater than about 75 wt. %. It will be appreciated that the water component content in the stucco-based slurry composition may be within a range between any of the minimum and maximum values noted above. It will be further appreciated that the water component content in the stucco-based slurry composition may be any value between any of the minimum and maximum values noted above.

Referring now to the second step 120 of forming the stucco-based slurry composition into a gypsum-based construction material that include a gypsum core, according to certain embodiments, the aforementioned stucco-based slurry composition or compositions may be deposited to form a gypsum preform of a gypsum-based construction material preform. According to still other embodiments, the gypsum preform can then be dried to make a gypsum core, converting the stucco component into a gypsum component.

According to still other embodiments, the aforementioned stucco-based slurry composition or compositions may be casted to form a gypsum-based construction material such as, a panel, a board, walls, plinths, slabs, columns, sheets, casts, or shafts.

According to still other embodiments, the gypsum core may include a particular gypsum component content, where the gypsum component content is equal to the content of the gypsum component in the gypsum core in weight percent (wt. %) for a total weight of the gypsum core. For example, the gypsum core may include a gypsum component content of at least about 10 wt. % for a total weight of the gypsum core, such as, at least about 15 wt. % or at least about 20 wt. % or at least about 25 wt. % or at least about 30 wt. % or at least about 35 wt. % or at least about 40 wt. % or even at least about 45 wt. %. According to still other embodiments, the gypsum core may include a gypsum component content of not greater than about 95 wt. % for a total weight of the gypsum core, such as, not greater than about 90 wt. % or not greater than about 85 wt. % or not greater than about 80 wt. % or not greater than about 75 wt. % or not greater than about 70 wt. % or not greater than about 65 wt. % or not greater than about 60 wt. % or even not greater than about 55 wt. %. It will be appreciated that the gypsum component content in the gypsum core may be within a range between any of the minimum and maximum values noted above. It will be further appreciated that the gypsum component content in the gypsum core may be any value between any of the minimum and maximum values noted above.

According to yet other embodiments, the gypsum core may further include a reinforcement component. According to certain embodiments, the reinforcement component may include glass fibers. According to still other embodiments, the reinforcement component may consist essentially of glass fibers.

According to still other embodiments, the gypsum core may include a particular reinforcement component content, where the reinforcement component content is equal to the content of the reinforcement component in the gypsum core in weight percent (wt. %) relative to the total weight of the gypsum component in the gypsum core. For example, the gypsum core may include a reinforcement component content of at least about 0.03 wt. % relative to the total weight of the gypsum component in the gypsum core, such as, at least about 0.05 wt. % or at least about 0.1 wt. % or at least about 0.5 wt. % or at least about 1.0 wt. % or at least about 1.5 wt. % or at least about 2.0 wt. % or even at least about 2.5 wt. %. According to still other embodiments, the gypsum core may include a reinforcement component content of not greater than about 10 wt. % for a total weight of the gypsum core, such as, not greater than about 9.5 wt. % or not greater than about 8.0 wt. % or not greater than about 8.5 wt. % or not greater than about 8.0 wt. % or not greater than about 7.5 wt. % or not greater than about 7.0 wt. % or not greater than about 6.5 wt. % or not greater than about 6.0 wt. % or even not greater than about 5.5 wt. %. It will be appreciated that the reinforcement component content in the gypsum core may be within a range between any of the minimum and maximum values noted above. It will be further appreciated that the reinforcement component content in the gypsum core may be any value between any of the minimum and maximum values noted above.

According to still other embodiments, the gypsum core may include a particular dispersant component content, where the dispersant component content is equal to the content of the dispersant component in the gypsum core in weight percent (wt. %) relative to the total weight of the gypsum component in the gypsum core. For example, the gypsum core may include a dispersant component content of at least about 0.1 wt. % relative to the total weight of the gypsum component in the gypsum core, such as, at least about 0.15 wt. % or at least about 0.20 wt. % or at least about 0.25 wt. % or at least about 0.30 wt. % or at least about 0.35 wt. % or at least about 0.40 wt. % or even at least about 0.45 wt. %. According to still other embodiments, the gypsum core may include a dispersant component content of not greater than about 1.0 wt. % for a total weight of the gypsum core, such as, not greater than about 0.95 wt. % or not greater than about 0.90 wt. % or not greater than about 0.85 wt. % or not greater than about 0.80 wt. % or not greater than about 0.75 wt. % or not greater than about 0.70 wt. % or not greater than about 0.65 wt. % or not greater than about 0.60 wt. % or even not greater than about 0.55 wt. %. It will be appreciated that the dispersant component content in the gypsum core may be within a range between any of the minimum and maximum values noted above. It will be further appreciated that the dispersant component content in the gypsum core may be any value between any of the minimum and maximum values noted above.

According to still other embodiments, the gypsum core may have a particular bubble structure as measured and analyzed according to a gypsum core bubble analysis method described by U.S. patent application Ser. No. 18/481,315, incorporated herein by reference in its entirety.

For purposes of embodiments described herein, core bubble analysis method is conducted according to the following protocol: 1) provide a sample of the gypsum core to be analyzed, 2) form a cut surface that extends across the sample of the gypsum core, 3) capture an image of a region of the cut surface, 4) capture a 2D image of the region of the cut surface, 5) analyze the image to identify bubbles having a diameter of at least 50 micrometers intersecting the cut surface, 6) determine, from the identified bubbles, a set of contacting bubbles each of which is in contact with at least one other bubble, 7) determine, based on the set of contacting bubbles, a measure of bubble contact in the gypsum core based on the identified bubbles in the image; and based on the measure of bubble contact, modifying a first operating parameter of the plurality of operating parameters for forming the porous slurry layer on the receiving surface.

It will be appreciated that the term “bubble” as used herein refers to an open space within the gypsum core that has an identifiable boundary to distinguish the area or volume of the bubble from the gypsum material and from neighboring bubbles. Thus, an open space within the gypsum core may be formed by a single bubble or may be formed by two or more bubbles that are in contact. Bubbles in contact with one another may have started to coalesce but still be identifiable as individual elements based on the shape of the open space within the gypsum. Accordingly, within a gypsum core there may be many bubbles, some of which are in contact with one another.

According to particular embodiments, the gypsum core as described herein may have a particular core bubble median size (D50) as measured using the gypsum core bubble analysis method described herein. It will be appreciated that the core bubble median size (D50) may be defined as the average bubble diameter (i.e., 50% of the bubble diameters are smaller than the value) and is measured according to the gypsum core bubble analysis method described herein. According to certain embodiments, the gypsum core may have a core bubble median size (D50) of at least about 150 microns, such as, at least about 160 microns or at least about 170 microns or at least about 180 microns or at least about 190 microns or at least about 200 microns or at least about 210 microns or at least about 220 microns or at least about 230 microns or at least about 240 microns or at least about 250 microns or at least about 260 microns or at least about 270 microns or at least about 280 microns or at least about 290 microns or even at least about 300 microns. According to still other embodiments, the gypsum core may have a core bubble median size (D50) of not greater than about 600 microns, such as, not greater than about 590 microns or not greater than about 580 microns or not greater than about 570 microns or not greater than about 560 microns or not greater than about 550 microns or not greater than about 540 microns or not greater than about 530 microns or not greater than about 520 microns or not greater than about 510 microns or not greater than about 500 microns or not greater than about 490 microns or not greater than about 480 microns or not greater than about 470 microns or not greater than about 460 microns or even not greater than about 450 microns. It will be appreciated that the gypsum core may have a core bubble median size (D50) within a range between any of the minimum and maximum values noted above. It will be further appreciated that the gypsum core may have a core bubble median size (D50) of any value between any of the minimum and maximum values noted above.

According to particular embodiments, the gypsum core as described herein may have a particular contacting bubble surface percentage (%) as measured using the gypsum core bubble analysis method described herein. It will be appreciated that the contacting bubble surface percentage (%) may be defined as a percentage of bubble within the gypsum core that are in contact with at least one other bubble within the gypsum core and is measured according to the gypsum core bubble analysis method described herein. According to certain embodiments, the gypsum core may have a core bubble median size (D50) of at least about 50%, such as, not greater than about 48% or not greater than about 45% or not greater than about 43% or not greater than about 40% or not greater than about 35% or not greater than about 33% or not greater than about 30% or not greater than about 28% or even not greater than about 25%. It will be appreciated that the gypsum core may have a contacting bubble surface percentage (%) within a range between any of the values noted above. It will be further appreciated that the gypsum core may have a contacting bubble surface percentage (%) of any value between any of the values noted above.

According to particular embodiments, the gypsum core as described herein may have a particular water absorption. It will be appreciated that the water absorption may be the percentage of water absorbed by the gypsum core as measured according to ASTM C473. According to certain embodiments, the gypsum core may have a water absorption of not greater than about 5.0%, such as, not greater than about 4.8% or not greater than about 4.5% or not greater than about 4.3% or not greater than about 4.0% or not greater than about 3.5% or not greater than about 3.3% or not greater than about 3.0% or not greater than about 2.8% or even not greater than about 2.5%. It will be appreciated that the gypsum core may have a water absorption within a range between any of the values noted above. It will be further appreciated that the gypsum core may have a water absorption of any value between any of the values noted above.

According to yet other embodiments, the gypsum-based construction material may be rated for 2 hours total water absorption as defined and measured in ASTM C473.

According to particular embodiments, the gypsum-based construction material as described herein may have a particular water absorption. It will be appreciated that the water absorption may be the percentage of water absorbed by the gypsum-based construction material as measured according to ASTM C473. According to certain embodiments, the gypsum-based construction material may have a water absorption of not greater than about 5.0%, such as, not greater than about 4.8% or not greater than about 4.5% or not greater than about 4.3% or not greater than about 4.0% or not greater than about 3.5% or not greater than about 3.3% or not greater than about 3.0% or not greater than about 2.8% or even not greater than about 2.5%. It will be appreciated that the gypsum-based construction material may have a water absorption within a range between any of the values noted above. It will be further appreciated that the gypsum-based construction material may have a water absorption of any value between any of the values noted above.

According to yet other embodiments, the gypsum-based construction material may be rated for 2 hours total water absorption as defined and measured in ASTM C473.

According to yet other embodiments, the gypsum core may have a particular thickness. For example, the gypsum core may have a thickness of at least about 5.0 mm, such as, at least about 6.0 mm or at least about 7.0 mm or at least about 8.0 mm or at least about 9.0 mm or at least about 10.0 mm or at least about 11.0 mm or at least about 12.0 mm or at least about 13.0 mm or at least about 14.0 mm or even at least about 15.0 mm. According to still other embodiments, the gypsum core may have a thickness of not greater than about 30 mm, such as, not greater than about 29.0 mm or not greater than about 28.0 mm or not greater than about 27.0 mm or not greater than about 26.0 mm or not greater than about 25.0 mm or not greater than about 24.0 mm or not greater than about 23.0 mm or not greater than about 22.0 mm or not greater than about 21.0 mm or even not greater than about 20.0 mm. It will be appreciated that the gypsum core may have a thickness within a range between any of the minimum and maximum values noted above. It will be further appreciated that the gypsum core may have a thickness of any value between any of the minimum and maximum values noted above.

According to yet other embodiments, the gypsum core may have a particular surface density. For example, the gypsum core may have a surface density of at least about 1150 lbs./msf, such as, at least about 1200 lbs./msf or at least about 1250 lbs./msf or at least about 1300 lbs./msf or at least about 1350 lbs./msf or at least about 1400 lbs./msf or at least about 1450 lbs./msf or at least about 1500 lbs./msf or at least about 1550 lbs./msf or at least about 1600 lbs./msf or even at least about 1650 lbs./msf. According to still other embodiments, the gypsum core may have a surface density of not greater than about 2550 lbs./msf, such as, not greater than about 2500 lbs./msf or not greater than about 2450 lbs./msf or not greater than about 2400 lbs./msf or not greater than about 2350 lbs./msf or not greater than about 2300 lbs./msf or not greater than about 2250 lbs./msf or not greater than about 2200 lbs./msf or not greater than about 2150 lbs./msf or not greater than about 2100 lbs./msf or even not greater than about 2050 lbs./msf. It will be appreciated that the gypsum core may have a surface density within a range between any of the minimum and maximum values noted above. It will be further appreciated that the gypsum core may have a surface density of any value between any of the minimum and maximum values noted above.

According to yet other embodiments, the gypsum-based construction material may have a particular thickness. For example, the gypsum-based construction material may have a thickness of at least about 5.0 mm, such as, at least about 6.0 mm or at least about 7.0 mm or at least about 8.0 mm or at least about 9.0 mm or at least about 10.0 mm or at least about 11.0 mm or at least about 12.0 mm or at least about 13.0 mm or at least about 14.0 mm or even at least about 15.0 mm. According to still other embodiments, the gypsum-based construction material may have a thickness of not greater than about 30 mm, such as, not greater than about 29.0 mm or not greater than about 28.0 mm or not greater than about 27.0 mm or not greater than about 26.0 mm or not greater than about 25.0 mm or not greater than about 24.0 mm or not greater than about 23.0 mm or not greater than about 22.0 mm or not greater than about 21.0 mm or even not greater than about 20.0 mm. It will be appreciated that the gypsum-based construction material may have a thickness within a range between any of the minimum and maximum values noted above. It will be further appreciated that the gypsum-based construction material may have a thickness of any value between any of the minimum and maximum values noted above.

According to yet other embodiments, the gypsum-based construction material may have a particular surface density. For example, the gypsum-based construction material may have a surface density of at least about 1150 lbs./msf, such as, at least about 1200 lbs./msf or at least about 1250 lbs./msf or at least about 1300 lbs./msf or at least about 1350 lbs./msf or at least about 1400 lbs./msf or at least about 1450 lbs./msf or at least about 1500 lbs./msf or at least about 1550 lbs./msf or at least about 1600 lbs./msf or even at least about 1650 lbs./msf. According to still other embodiments, the gypsum-based construction material may have a surface density of not greater than about 2550 lbs./msf, such as, not greater than about 2500 lbs./msf or not greater than about 2450 lbs./msf or not greater than about 2400 lbs./msf or not greater than about 2350 lbs./msf or not greater than about 2300 lbs./msf or not greater than about 2250 lbs./msf or not greater than about 2200 lbs./msf or not greater than about 2150 lbs./msf or not greater than about 2100 lbs./msf or even not greater than about 2050 lbs./msf. It will be appreciated that the gypsum-based construction material may have a surface density within a range between any of the minimum and maximum values noted above. It will be further appreciated that the gypsum-based construction material may have a surface density of any value between any of the minimum and maximum values noted above.

According to still other embodiments, the gypsum-based construction material may include a second gypsum layer that may be denser than the gypsum core.

In an embodiment, the gypsum-based construction material can further include at least one liner. The liner may be a particular material that may facilitate improved performance and/or manufacturing of the gypsum-based construction material. In an embodiment, the liner may comprise a paper liner, a glass mat liner, or any combination thereof.

Turning now to alternative method of producing the desired bubble characteristics described herein, such characteristics may be achieved with stable surfactants by further turbulence to the forming mixture, combining them with gentle agitation and enough residence time to allow the more stable bubbles to coalesce in an ideal environment and conditions.

Many different aspects and embodiments are possible. Some of those aspects and embodiments are described herein. After reading this specification, skilled artisans will appreciate that those aspects and embodiments are only illustrative and do not limit the scope of the present invention. Embodiments may be in accordance with any one or more of the embodiments as listed below.

Embodiment 1. A method of forming a gypsum-based construction material, wherein the method comprises: providing a stucco-based slurry composition comprising a surfactant at a content of at least about 0.10 wt. % and not greater than about 1.0 wt. % for a total weight of the stucco-based slurry composition, wherein the surfactant comprises an alkyl ether sulfate, an ethoxylated surfactant, a lauryl surfactant, an alcohol, or any combination thereof, and forming the stucco-based slurry composition into a gypsum-based construction material comprising a gypsum core, wherein the gypsum core comprises: a core bubble median size (D50) of at least about 150 microns and not greater than about 600 microns, a contacting bubble surface percentage of not greater than about 50%, and a water absorption of not greater than about 5.0%.

Embodiment 2. A gypsum-based construction material formed from a stucco-based slurry composition, wherein the stucco-based slurry composition comprises a surfactant at a content of at least about 0.10 wt. % and not greater than about 1.0 wt. % for a total weight of the stucco-based slurry composition, wherein the surfactant comprises an alkyl ether sulfate, an ethoxylated surfactant, a lauryl surfactant, an alcohol, or any combination thereof, wherein the gypsum-based construction material comprising a gypsum core, and wherein the gypsum core comprises: a core bubble median size (D50) of at least about 150 microns and not greater than about 600 microns, a contacting bubble surface percentage of not greater than about 50%, and a water absorption of not greater than about 5.0%.

Embodiment 3. A gypsum-based construction material comprising a gypsum core, wherein the gypsum core comprises: a core bubble median size (D50) of at least about 150 microns and not greater than about 600 microns, a contacting bubble surface percentage of not greater than about 50%, and a water absorption of not greater than about 5.0%.

Embodiment 4. The method or gypsum-based construction material of any one of embodiments 1, 2, and 3, wherein the stucco-based slurry composition comprises the surfactant at a content of at least about 0.10 wt. % for a total weight of the stucco-based slurry composition.

Embodiment 5. The method or gypsum-based construction material of any one of embodiments 1, 2, and 3, wherein the stucco-based slurry composition comprises the surfactant at a content of not greater than about 1.0 wt. % for a total weight of the stucco-based slurry composition.

Embodiment 6. The method or gypsum-based construction material of any one of embodiments 1, 2, and 3, wherein the gypsum core comprises a core bubble median size (D50) of at least about 150 microns.

Embodiment 7. The method or gypsum-based construction material of any one of embodiments 1, 2, and 3, wherein the gypsum core comprises a core bubble median size (D50) of not greater than about 600 microns.

Embodiment 8. The method or gypsum-based construction material of any one of embodiments 1, 2, and 3, wherein the gypsum core comprises a contacting bubble surface percentage of not greater than about 50%, where the contacting bubble surface percentage is defined as percentage of bubbles each of which is in contact with at least one other bubble.

Embodiment 9. The method or gypsum-based construction material of any one of embodiments 1, 2, and 3, wherein the gypsum core comprises a water absorption of not greater than about 5.0%.

Embodiment 10. The method or gypsum-based construction material of any one of embodiments 1, 2, and 3, wherein the gypsum-based construction material comprises a water absorption of not greater than about 5%.

Embodiment 11. The method of embodiment 1 and 2, wherein forming the gypsum-based construction material forming composition into the gypsum-based construction material comprises: depositing the gypsum-based construction material forming composition to form a gypsum preform of the gypsum-based construction material forming composition, and drying the gypsum prefrom of the gypsum-based construction material forming composition to form a gypsum core.

Embodiment 12. The method or gypsum-based construction material of any one of embodiments 1, 2, and 3, wherein the construction material has a thickness of at least 5.0 mm.

Embodiment 13. The method or gypsum-based construction material of any one of embodiments 1, 2, and 3, wherein the construction material has a thickness of less than 30 mm.

Embodiment 14. The method or gypsum-based construction material of any one of embodiments 1, 2, and 3, wherein the construction material has a surface density of at least 1150 lbs./msf.

Embodiment 15. The method or gypsum-based construction material of any one of embodiments 1, 2, and 3, wherein the construction material has a surface density of less than 2550 lbs./msf.

Embodiment 16. The method or gypsum-based construction material of any one of embodiments 1, 2, and 3, wherein the gypsum-based construction material further comprises at least one liner.

Embodiment 17. The gypsum-based construction material or method of embodiment 16, wherein the at least one liner comprises a paper liner, a glass mat liner, or any combination thereof.

Embodiment 18. The method or gypsum-based construction material of any one of embodiments 1, 2, and 3, wherein the stucco-based slurry composition comprises a stucco component.

Embodiment 19. The method or gypsum-based construction material of embodiment 18, wherein the stucco-based slurry composition comprises the stucco component at a content of at least about 10 wt. % for a total weight of the stucco-based slurry composition.

Embodiment 20. The method or gypsum-based construction material of embodiment 18, wherein the stucco-based slurry composition comprises the stucco component at a content of not greater than about 95 wt. % for a total weight of the stucco-based slurry composition.

Embodiment 21. The method or gypsum-based construction material of embodiment 18, wherein the stucco component comprises of synthetic, natural, or recycle stucco or the combination thereof.

Embodiment 22. The method or gypsum-based construction material of embodiment 18, wherein the stucco-based slurry composition comprises a reinforcement component.

Embodiment 23. The method or gypsum-based construction material of embodiment 22, wherein the reinforcement component comprises glass fiber.

Embodiment 24. The method or gypsum-based construction material of embodiment 22, wherein the stucco-based slurry composition comprises a reinforcement content of at least about 0.03 wt. % relative to the content of stucco component.

Embodiment 25. The method or gypsum-based construction material of embodiment 22, wherein the stucco-based slurry composition comprises a reinforcement content of not greater than about 10 wt. % relative to the content of stucco component.

Embodiment 26. The method or gypsum-based construction material of embodiment 18, wherein the stucco-based slurry composition comprises a starch component.

Embodiment 27. The method or gypsum-based construction material of embodiment 26, wherein the starch component comprises an acid modified starch, a chemically modified starch, a natural starch, such as, a corn starch, a sorghum starch, a wheat starch, a tapioca starch, a rice starch, a pea starch, a potato starch, a maize starch, or any combination thereof.

Embodiment 28. The method or gypsum-based construction material of embodiment 26, wherein the stucco-based slurry composition comprises the starch component at a content of at least about 0.001 wt. % relative to the content of the stucco component.

Embodiment 29. The method or gypsum-based construction material of embodiment 26, wherein the stucco-based slurry composition comprises the starch component at a content of not greater than about 1.5 wt. % relative to the content of the stucco component.

Embodiment 30. The method or gypsum-based construction material of embodiment 18, wherein the stucco-based slurry composition comprises an accelerator component.

Embodiment 31. The method or gypsum-based construction material of embodiment 30, wherein the accelerator component comprises a heat-resistant gypsum accelerator (both in solid and liquid form).

Embodiment 32. The method or gypsum-based construction material of embodiment 30, wherein the stucco-based slurry composition comprises the accelerator component at a content of at least about 0.1 wt. % relative to the content of the stucco component.

Embodiment 33. The method or gypsum-based construction material of embodiment 30, wherein the stucco-based slurry composition comprises the accelerator component at a content of not greater than about 5.0 wt. % relative to the content of the stucco component.

Embodiment 34. The method or gypsum-based construction material of embodiment 18, wherein the stucco-based slurry composition comprises a guar gum component.

Embodiment 35. The method or gypsum-based construction material of embodiment 34, wherein the guar gum component comprises a native guar gum, a chemically modified guar gum, or any combination thereof.

Embodiment 36. The method or gypsum-based construction material of embodiment 18, wherein the stucco-based slurry composition comprises a siloxane.

Embodiment 37. The method or gypsum-based construction material of embodiment 36, wherein the siloxane comprises PMHS, PDMS, a silanol containing siloxane, or any combination thereof.

Embodiment 38. The method or gypsum-based construction material of embodiment 36, wherein the stucco-based slurry composition comprises a siloxane content of at least about 0.01 wt. % relative to the content of the stucco component.

Embodiment 39. The method or gypsum-based construction material of embodiment 36, wherein the stucco-based slurry composition comprises a siloxane content of not greater than about 2.0 wt. % relative to the content of the stucco component.

Embodiment 40. The method or gypsum-based construction material of embodiment 18, wherein the stucco-based slurry composition comprises a dispersant component.

Embodiment 41. The method or gypsum-based construction material of embodiment 40, wherein the precursor dispersant component comprises polynaphthalene sulfonate, ligno sulfonate, polyaryl ether poly carboxylate or any combination thereof.

Embodiment 42. The method or gypsum-based construction material of embodiment 40, wherein the stucco-based slurry composition comprises the dispersant component at a content of at least about 0.1 wt. % relative to the content of the stucco component.

Embodiment 43. The method or gypsum-based construction material of embodiment 40, wherein the stucco-based slurry composition comprises the dispersant component at a content of not greater than about 1 wt. % relative to the content of the precursor stucco component.

Embodiment 44. The method or gypsum-based construction material of embodiment 18, wherein the stucco-based slurry composition comprises a water component.

Embodiment 45. The method or gypsum-based construction material of embodiment 44, wherein the stucco-based slurry composition comprises the water component at a content at least 50% relative to the content of the stucco component.

Embodiment 46. The method or gypsum-based construction material of embodiment 44, wherein the stucco-based slurry composition comprises the water component at a content of not greater than 90% relative to the content of the stucco component.

Embodiment 47. The method or gypsum-based construction material of any one of embodiments 1, 2, and 3, wherein the stucco-based slurry composition further comprises a dispersant component.

Embodiment 48. The method or gypsum-based construction material of embodiment 47, wherein the stucco-based slurry composition comprises the dispersant component at a content of at least about 0.1 wt. % relative to the content of the stucco component.

Embodiment 49. The method or gypsum-based construction material of embodiment 47, wherein the stucco-based slurry composition comprises the dispersant component at a content of not greater than about 1.0 wt. % relative to the content of the stucco component.

Embodiment 50. The method or gypsum-based construction material of embodiment 47, wherein the stucco-based slurry composition comprises the dispersant component.

Embodiment 51. A method of forming a gypsum-based construction material, wherein the method comprises: providing a stucco-based slurry composition comprising a dispersant component at a content of at least about 0.1 wt. % and not greater than about 1.0 wt. % for a total weight of the stucco-based slurry composition, and forming the stucco-based slurry composition into a gypsum-based construction material comprising a gypsum core, wherein the gypsum core comprises: a core bubble median size (D50) of at least about 150 microns and not greater than about 600 microns, a contacting bubble surface percentage of not greater than about 50%, and a water absorption of not greater than about 5.0%.

Embodiment 52. A gypsum-based construction material formed from a stucco-based slurry composition, wherein the stucco-based slurry composition comprises a dispersant component at a content of at least about 0.1 wt. % and not greater than about 1.0 wt. % for a total weight of the stucco-based slurry composition, wherein the gypsum-based construction material comprising a gypsum core, and wherein the gypsum core comprises: a core bubble median size (D50) of at least about 150 microns and not greater than about 600 microns, a contacting bubble surface percentage of not greater than about 50%, and a water absorption of not greater than about 5.0%.

### EXAMPLES

### Example 1

The following non-limiting examples illustrate the embodiments described herein.

Samples S1-S3 were prepared according to the process below. To prepare the boards, 500 g stucco was mixed with 17 g of 1% retardant in water solution (0.03 wt. % retardant based on the weight of the stucco), 400 g water (about 400 g water total with the retardant solution), 1.55 g starch (0.3 wt. % based on the weight of the stucco), 2 g of a gypsum accelerator (0.4 wt. % based on the weight of the stucco), 0.5 g of dispersant (0.10 wt. % based on the weight of the stucco). Surfactant solution (1 wt. %) was foamed and then injected into the gypsum slurry to achieve a ⅝ inches thick board with board surface density target at 2400 lbs./msf. Gypsum slurry was then allowed to set and dried to remove excess water, forming the final gypsum board. Bubble median size, contacting bubble surface, and after absorption were measured according to the gypsum core bubble analysis method described herein. Results can be found in Table 1 below.

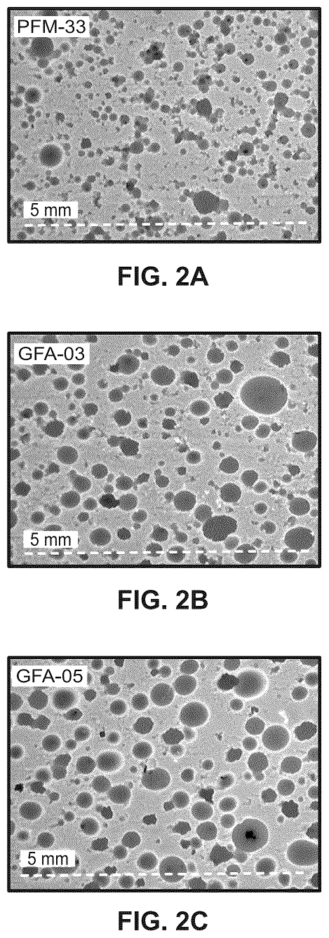

TABLE 1

| | | Bubble | Contacting | Water | |
|---|---|---|---|---|---|
| | Surf. | Median Size | Bubble | Absorption | |
| Sample | Type | D₅₀ (um) | Surface (%) | (%) | Image |
| S1 | Stable | 163 | 39.1 | 5.6 | FIG. 2A |
| S2 | Unstable | 245 | 21.4 | 5.1 | FIG. 2B |
| S3 | Unstable | 317 | 16.7 | 4.9 | FIG. 2C |

Images of the gypsum boards for samples S1-S3 and can be found in FIGS. 2A-C.

### Example 2

The following non-limiting examples illustrate the embodiments described herein.

Samples S4 and S5 were prepared according to the process below. To prepare the boards, 500 g stucco was mixed with 17 g of 1% retardant in water solution (0.03 wt. % retardant based on the weight of the stucco), 400 g water (about 400 g water total with the retardant solution), 1.55 g starch (0.3 wt. % based on the weight of the stucco), 2 g of a gypsum accelerator (0.4 wt. % based on the weight of the stucco), 0.5 g of dispersant (0.10 wt. % based on the weight of the stucco) and 0.42 wt. % silicone oil. Surfactant solution (0.75 wt. % or 1.25 wt. %) was then injected into the gypsum slurry to achieve a ⅝ inches thick board with board surface density target at 2400 lbs./msf. Gypsum slurry was then allowed to set and dried to remove excess water, forming the final gypsum board. Bubble median size, contacting bubble surface, and after absorption were measured according to the gypsum core bubble analysis method described herein. Results can be found in Table 2 below.

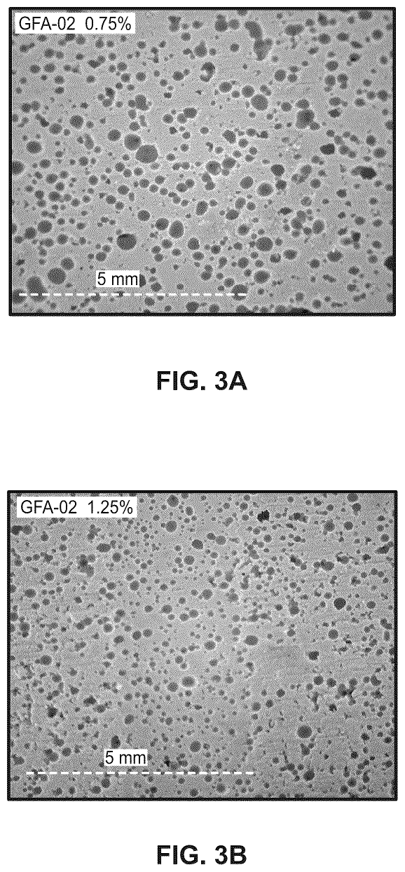

TABLE 2

| | | | Bubble | Contacting | Water | |
|---|---|---|---|---|---|---|
| | | Surf. | Median | Bubble | Absorp- | |
| | Surf. | Content | size D₅₀ | Surface | tion | |
| Sample | Type | (wt. %) | (um) | (%) | (%) | Image |
| S4 | Unstable | 0.75 | 218 | 22.2 | 4.6 | FIG. 3A |
| S5 | Unstable | 1.25 | 158 | 30.4 | 4.9 | FIG. 3B |

Images of the gypsum boards for samples S4 and S5 can be found in FIGS. 3A & 3B.

### Example 3

The following non-limiting examples illustrate the embodiments described herein.

Samples S6 and S7 were prepared according to the process above, except that the surfactant content is set at 0.425 wt. % and the dispersant content is varied from 0.42 wt. % to 0.51 wt. % based on the weight of the board.

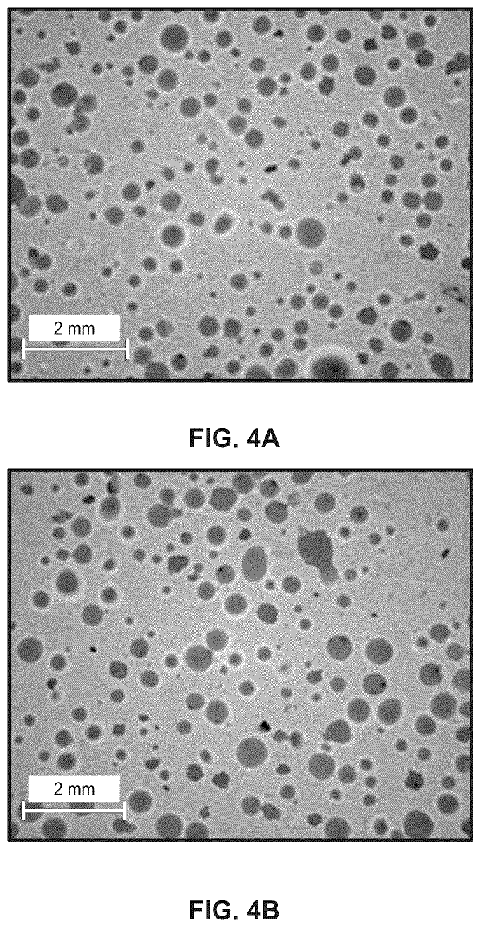

TABLE 3

| | | Disp. | | Surf. | Bubble | Contacting | Water | |
|---|---|---|---|---|---|---|---|---|
| | Disp. | Content | Surf. | Content | Median Size | Bubble | Absorption | |
| Sample | Type | (wt. %) | Type | (wt. %) | D₅₀ (um) | Surface (%) | (%) | Image |
| S6 | PNS | 0.42 | Unstable | 0.425 | 337 | 15.8 | 5.3 | FIG. 4A |
| S7 | PNS | 0.51 | Unstable | 0.425 | 405 | 9.1 | 5.1 | FIG. 4B |

Images of the gypsum boards for samples S6 and S7 can be found in FIGS. 4A & 4B.

In the foregoing specification, the concepts have been described with reference to specific embodiments. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of the invention.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

What is claimed is:

1. A gypsum-based construction material comprising a gypsum core, wherein the gypsum core comprises:
a core bubble median size (D50) of at least about 150 microns and not greater than about 600 microns,
a contacting bubble surface percentage of not greater than about 50%, and
a water absorption of not greater than about 5.0%.

2. The gypsum-based construction material of claim 1, wherein the gypsum-based construction material formed from a stucco-based slurry composition,
wherein the stucco-based slurry composition comprises a surfactant at a content of at least about 0.10 wt. % and not greater than about 1.0 wt. % for a total weight of the stucco-based slurry composition, and
wherein the surfactant comprises an alkyl ether sulfate, an ethoxylated surfactant, a lauryl surfactant, an alcohol, or any combination thereof.

3. The gypsum-based construction material of claim 2, wherein the stucco-based slurry composition comprises a stucco component.

4. The gypsum-based construction material of claim 3, wherein the stucco-based slurry composition comprises the stucco component at a content of at least about 10 wt. % for a total weight of the stucco-based slurry composition.

5. The gypsum-based construction material of claim 4, wherein the stucco-based slurry composition comprises the stucco component at a content of not greater than about 95 wt. % for a total weight of the stucco-based slurry composition.

6. The gypsum-based construction material of claim 3, wherein the stucco component comprises of synthetic, natural, or recycled stucco or the combination thereof.

7. The gypsum-based construction material of claim 3, wherein the stucco-based slurry composition comprises a reinforcement component.

8. The gypsum-based construction material of claim 7, wherein the reinforcement component comprises glass fiber.

9. The gypsum-based construction material of claim 3, wherein the stucco-based slurry composition comprises a dispersant component.

10. The gypsum-based construction material of claim 9, wherein the dispersant component comprises polynaphthalene sulfonate, ligno sulfonate, polyaryl ether poly carboxylate or any combination thereof.

11. The gypsum-based construction material of claim 9, wherein the stucco-based slurry composition comprises the dispersant component at a content of at least about 0.1 wt. % and not greater than about 1 wt. % relative to the content of the stucco component.

12. The gypsum-based construction material of claim 1, wherein the gypsum-based construction material further comprises at least one liner, and wherein the at least one liner comprises a paper liner, a glass mat liner, or any combination thereof.

13. A method of forming a gypsum-based construction material, wherein the method comprises:
providing a stucco-based slurry composition comprising a surfactant at a content of at least about 0.10 wt. % and not greater than about 1.0 wt. % for a total weight of the stucco-based slurry composition, wherein the surfactant comprises an alkyl ether sulfate, an ethoxylated surfactant, a lauryl surfactant, an alcohol, or any combination thereof, and
forming the stucco-based slurry composition into a gypsum-based construction material comprising a gypsum core, wherein the gypsum core comprises:
a core bubble median size (D50) of at least about 150 microns and not greater than about 600 microns,
a contacting bubble surface percentage of not greater than about 50%, and
a water absorption of not greater than about 5.0%.

14. The method of claim 13, wherein forming the gypsum-based construction material forming composition into the gypsum-based construction material comprises:
depositing the gypsum-based construction material forming composition to form a gypsum preform of the gypsum-based construction material forming composition, and
drying the gypsum prefrom of the gypsum-based construction material forming composition to form a gypsum core.

15. The method of claim 13, wherein the stucco-based slurry composition comprises a dispersant component.

16. The method of claim 15, wherein the dispersant component comprises polynaphthalene sulfonate, ligno sulfonate, polyaryl ether poly carboxylate or any combination thereof.

17. The method of claim 15, wherein the stucco-based slurry composition comprises the dispersant component at a content of at least about 0.1 wt. % and not greater than about 1 wt. % relative to the content of the stucco component.

18. The method of claim 13, wherein the stucco-based slurry composition comprises a reinforcement component.

19. The method of claim 18, wherein the reinforcement component comprises glass fiber.

20. A gypsum-based construction material formed from a stucco-based slurry composition,
wherein the stucco-based slurry composition comprises a dispersant component at a content of at least about 0.1 wt. % and not greater than about 1.0 wt. % for a total weight of the stucco-based slurry composition,
wherein the gypsum-based construction material comprising a gypsum core, and wherein the gypsum core comprises:
a core bubble median size (D50) of at least about 150 microns and not greater than about 600 microns,
a contacting bubble surface percentage of not greater than about 50%, and
a water absorption of not greater than about 5.0%.
